(19) United States
(12) Patent Application Publication
(10) Pub. No.: US 2014/0348621 A1
(43) Pub. Date: Nov. 27, 2014

(54) Split Body Rear Load Refuse Truck

(71) Applicants: David J. Brisson, Norway, MI (US); Randall R. Brisson, Norway, MI (US)

(72) Inventors: David J. Brisson, Norway, MI (US); Randall R. Brisson, Norway, MI (US)

(21) Appl. No.: 14/282,797

(22) Filed: May 20, 2014

Related U.S. Application Data
(60) Provisional application No. 61/825,819, filed on May 21, 2013.

(51) Int. Cl. B65F 3/20

(52) U.S. Cl. CPC B65F 3/201
USPC 414/525.6

(57) ABSTRACT

A rear load refuse truck is used for collecting and compacting trash and recyclables, and includes a truck body, and a single tailgate pivotally connected to a rear end of the truck body between open and closed positions. The tailgate has interior walls defining an interior refuse collecting area divided into two chambers by a splitter mounted within the tailgate and adapted to receive trash and recyclables. A single blade is movably mounted within the interior walls for compacting refuse and is configured with a gap for receiving the splitter.

### CROSS-REFERENCE TO RELATED APPLICATION

The present utility application refers to and claims priority based on pending U.S. Provisional Patent Application Ser. No. 61/825,819, filed May 21, 2013, which is herein incorporated in its entirety.

### FIELD OF THE INVENTION

The present application is directed to the field of refuse trucks. More specifically, the present application is directed to the field of tailgate and split body structure for use with a refuse truck.

### BACKGROUND OF THE INVENTION

The split body rear load refuse truck of the present application is designed to improve upon the prior art split body refuse trucks currently being used in the marketplace. FIG. 1 of the present application illustrates a typical prior art split body refuse truck 100. As is apparent from this drawing, the prior art truck 100 has dual tailgates 102, 104, and in this drawing, one tailgate 102 is in an open position and a second tailgate 104 is in a closed position. The purpose of a split body refuse truck is to collect and carry two different types of refuse in the same truck, i.e., one side of the truck 100 is for trash and the other side of the truck 100 is for recyclables. However, there are many drawbacks to the current solution shown in FIG. 1.

This prior art split body refuse truck 100 requires two separate mounted tailgates 102, 104 on the back of the truck as illustrated. This truck 100 also requires each tailgate 102, 104 to include a separate hydraulic system and hydraulic control, including two separate sets of tailgate lift cylinders. The prior art split body refuse truck 100 also requires two sets of pack cylinders which are the cylinders that move the blade to compact the refuse into the truck. Of course, this requires two separate pack blade control valves as well.

All of this additional hardware makes the current split body refuse trucks 100 very heavy and oftentimes they require a high level of maintenance. These split body refuse trucks 100 are also not as efficient from a capacity standpoint, as there is more steel on the truck in order to facilitate the dual tailgates, which results in less room for refuse. The additional cylinders, controls and steel also make this truck 100 extremely expensive to produce.

Also, the design of the split body refuse truck 100 of FIG. 1 can make trash collection very dangerous for the operator of the truck. In this split body refuse truck 100, there are separate controls for each of the tailgates 102, 104 on either side of the truck 100. Therefore, there are tailgate controls for the driver's side tailgate that require the operator to be exposed to the road when the truck 100 is operating on the side of a road.

Lastly, the split body refuse trucks 100 as illustrated in FIG. 1 are not compatible with trash containers that are split to accommodate both trash and recyclables. The split body refuse truck 100 of FIG. 1 is limited to servicing single trash receptacles and/or single recyclable receptacles.

### SUMMARY OF THE INVENTION

The present application relates to a rear load refuse truck used for collecting and compacting trash and recyclables. The refuse truck includes a truck body, and a single tailgate pivotally connected to a rear end of the truck body between open and closed positions. The tailgate has interior walls defining an interior refuse collecting area divided into two chambers by a splitter mounted within the tailgate, and adapted to receive trash and recyclables. A single blade is movably mounted within the interior walls for compacting refuse and is configured with a gap for receiving the splitter.

In an exemplary embodiment, the splitter is vertically oriented within the tailgate. The tailgate is provided with a pair of tippers adapted to tip carts filled with refuse into the chambers. One of the tippers is aligned with one of the chambers, and another of the tippers is aligned with another of the chambers. The chambers are configured by side orientation. The blade is controlled by a single set of hydraulics and a pair of pack cylinders. The truck body is split and the truck body defines containment structures adapted to receive trash and recyclables. A single set of lift cylinders is provided between the truck body and the tailgate to move the tailgate between the open and closed positions. Hydraulic controls are provided for selectively operating the tailgate and are located on only the passenger side of the tailgate. The splitter may be mounted to divide the chambers into equal or different sized configurations.

### BRIEF DESCRIPTION OF THE DRAWINGS

The drawings illustrate the best mode presently contemplated of carrying out the invention. In the drawings:

FIG. 1 is a perspective view of a prior art split body refuse truck;

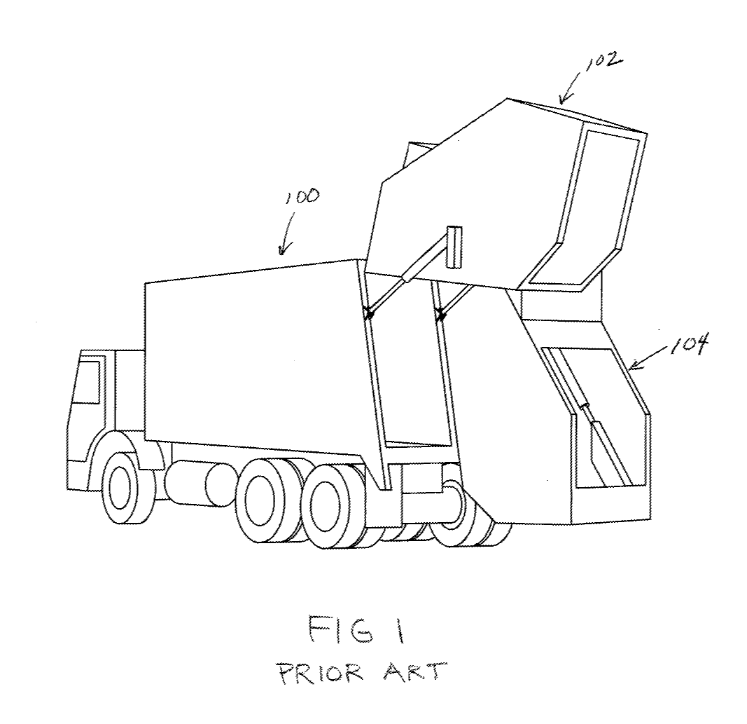

FIG. 2 is a rear perspective view of a split body refuse truck in accordance with the present disclosure;

FIG. 3 is an enlarged rear perspective view of the split body refuse truck shown in FIG. 2;

FIG. 4 is a rear left-side perspective view of the split body refuse truck showing dual cart tippers in operation;

FIG. 5 is a further rear perspective view of the split body refuse truck showing containment structures for trash material;

FIG. 6 is a view illustrating a set of cylinders used in the split body refuse truck in connection with the containment structures; and

FIG. 7 is a rear right-side perspective view of the split body refuse truck illustrating passenger side located hydraulic controls for the split body refuse truck.

### DETAILED DESCRIPTION OF THE DRAWINGS

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

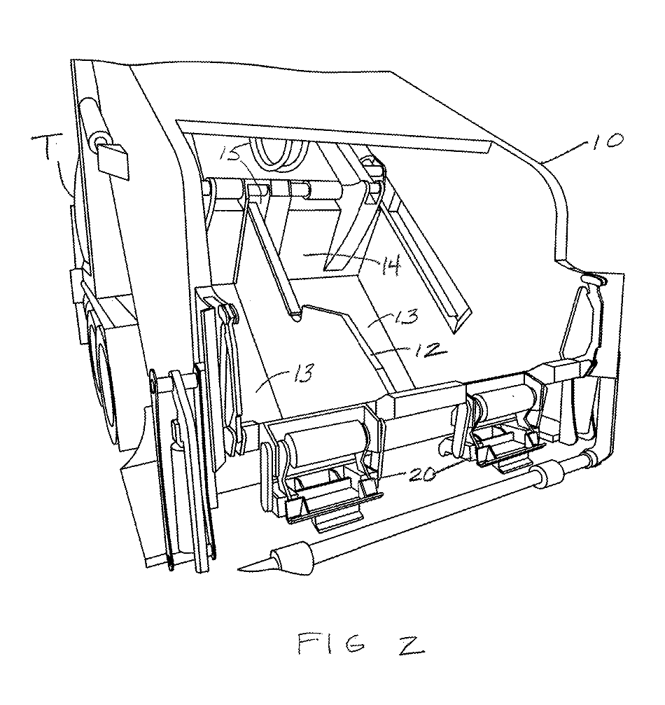

Referring to FIG. 2, the split body rear load refuse truck T of the present application includes a single tailgate 10 in a closed position and a single sweep partition blade 14 that is split with a gap 15 to accommodate a vertically-oriented splitter 12 of the tailgate 10. The splitter 12 divides interior walls defining an interior refuse collecting area of the tailgate 10 into side-by-side chambers 13. In this figure, the refuse truck T is shown with dual cart tippers 20, but may also accommodate a single cart tipper 20 for trucks that will collect single containers. This will be discussed in further detail below.

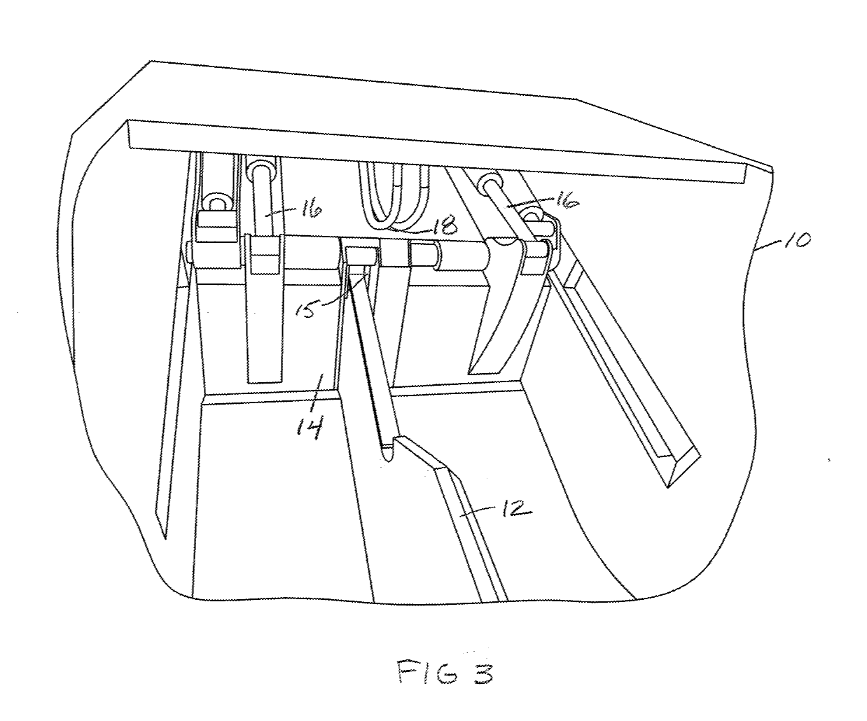

FIG. 3 illustrates the single sweep blade 14 controlled by a single set of hydraulics 18 and one pair of pack cylinders 16. In operation, the single blade 14 is moved along the interior walls of the tailgate 10 by the hydraulics 18 and the pack cylinders 16 to pull both the trash and recyclables on either side of the splitter 12 into the split body of the refuse truck T.

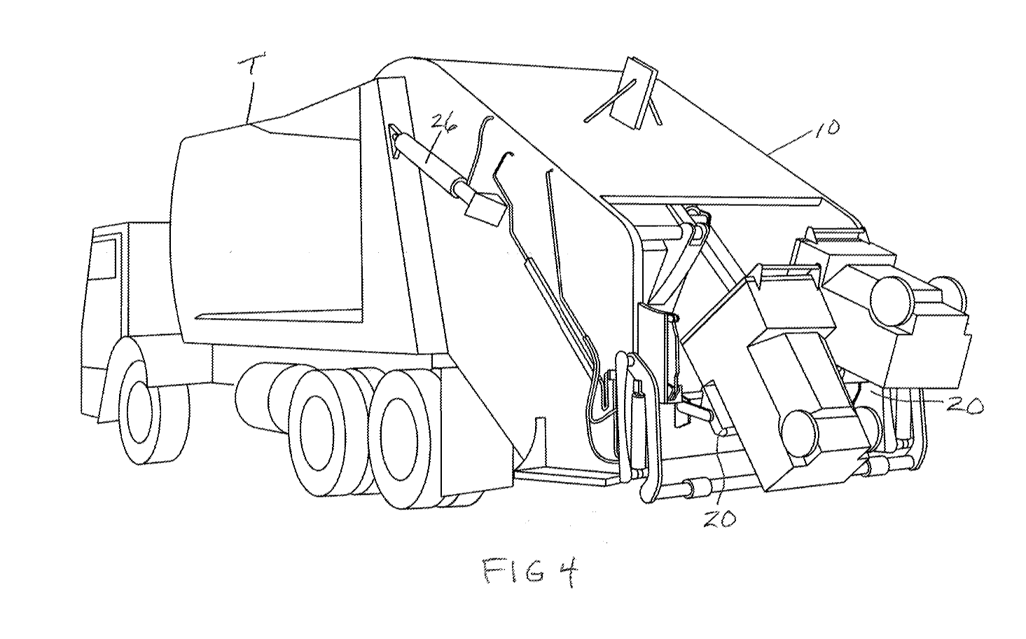

FIG. 4 illustrates the single tailgate 10 having dual cart tippers 20 in the process of tipping two separate containers into the tailgate 10. As stated previously, the tailgate 10 can accommodate a single cart tipper 20 for collecting refuse from a single split body container that includes both garbage and recyclables.

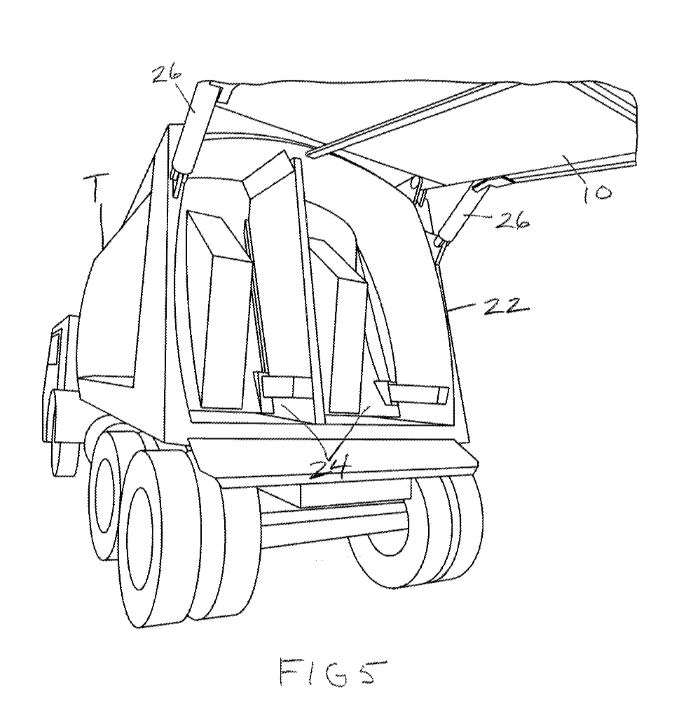

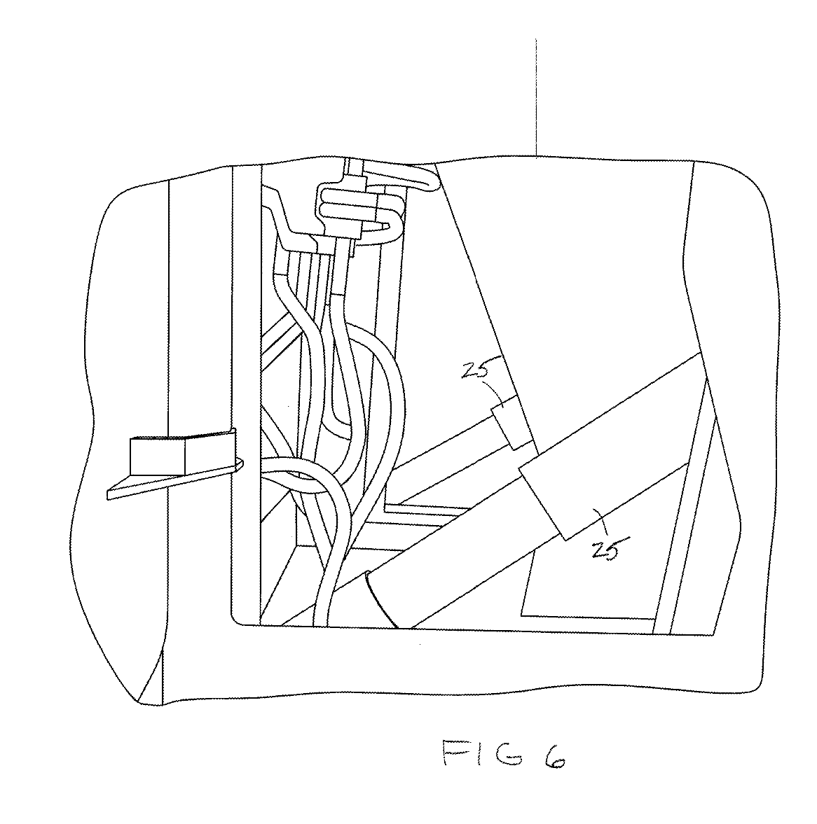

FIG. 5 illustrates the tailgate 10 in an open position and further illustrates the split body 22 of the refuse truck T including containment structures 24 for each of the trash and the recyclable material. The structures 24 are mounted for movement within the body 22 by means of a set of cylinders 25, as seen in FIG. 6.

FIG. 5 also illustrates a single set of tailgate lift cylinders 26 that operate to open the single tailgate 10 of the split body refuse truck T.

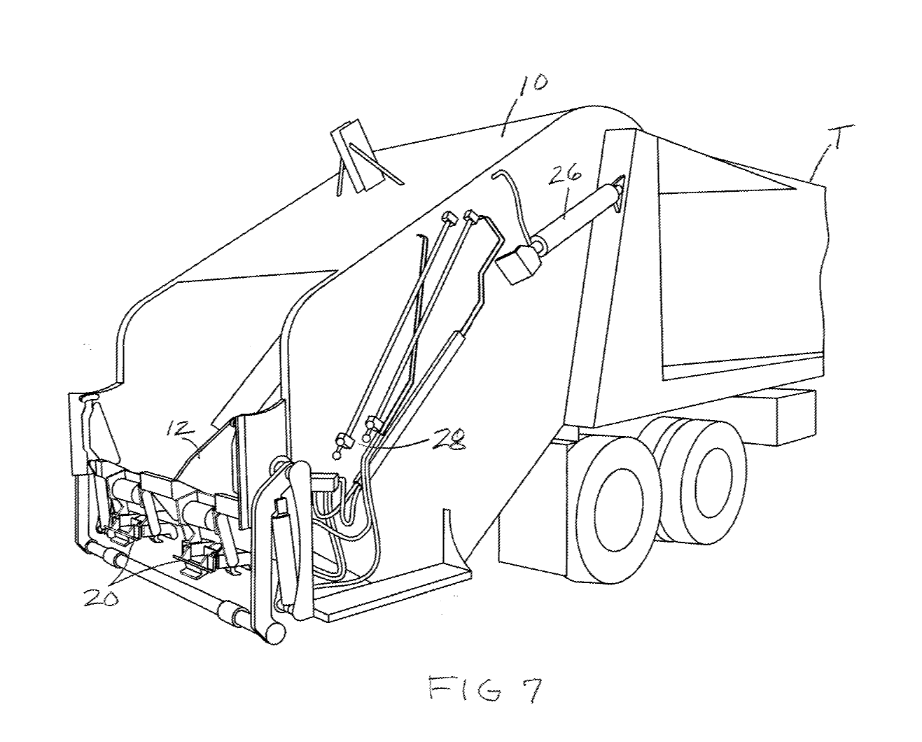

FIG. 7 illustrates a right-side perspective view of the split body refuse truck T and further illustrates hydraulic controls 28 located on a passenger side of the truck T and used for operating the various components, such as elements 14, 16, 18, 20, 25 and 26. As stated previously in the Background, prior art split body refuse trucks require two controls thus putting one set of controls on the driver's side, which is typically on the street side. The reduction of tailgates to a single tailgate design, allows the controls 28 to be placed on a safe, passenger's side of the split body refuse truck T.

The split body refuse truck T of the present application has multiple advantages over that described in the Background. The split body refuse truck T of the present application only includes one tailgate shell or body and one set of tailgate lift cylinders. The split body refuse truck T of the present application also includes one set of pack cylinders and one set of pack blade control valves. The split body refuse truck T of the present application is also compatible with a single split container that can handle both trash and recyclables while also being compatible with separate containers having trash and recyclables. As stated previously, it follows that the split body refuse truck T is compatible with single as well as dual cart tippers in order to accommodate the single or dual container configuration, respectively.

In one embodiment, the splitter 12 of the present application is configured such that it divides the inside of the tailgate 10 with the blade 14 into a 60%/40% configuration for trash and recyclables, respectively. It is contemplated by the Applicants that this percentage may change, and further that the operator of the truck T may want to convert the truck into a 100% trash or 100% recyclable truck. In such cases, the truck T may be converted to a 50/50 trash/recyclable truck by moving the splitter 12 and installing a blade 14 to accommodate the splitter 12, and may convert the split body refuse truck T to a 100% trash or recyclable truck by removing the splitter 12 and installing an appropriate blade 14.

This written description uses examples to disclose the invention, including the best mode, and also to enable any person skilled in the art to make anew the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A rear load refuse truck used for collecting and compacting trash and receptacles, the refuse truck comprising:
a truck body;
a single tailgate pivotally connected to a rear end of the truck body between open and closed positions, the tailgate having interior walls defining an interior refuse collecting area divided into two chambers by a splitter mounted within the tailgate, and adapted to receive trash and recyclables; and
a single blade movably mounted within the interior walls for compacting refuse and configured with a gap for receiving the splitter.

2. The refuse truck of claim 1, wherein the splitter is vertically oriented within the tailgate.

3. The refuse truck of claim 1, wherein the tailgate is provided with a pair of tippers adapted to the tip carts filled with refuse into the chambers, one of the tippers being aligned with one of the chambers, and another of the tippers being aligned with another of the chambers.

4. The refuse truck of claim 1, wherein the chambers are configured in side-by-side orientation.

5. The refuse truck of claim 1, wherein the blade is controlled by a single set of hydraulics and a pack of pack cylinders.

6. The refuse truck of claim 1, wherein the truck body is split.

7. The refuse truck of claim 1, wherein the truck body defines containment structures adapted to receive trash and recyclables.

8. The refuse truck of claim 1, wherein a single set of lift cylinders is provided between the truck body and the tailgate to move the tailgate between the open and closed positions.

9. The refuse truck of claim 1, wherein hydraulic controls for selectively operating the tailgate are located only on a passenger side of the tailgate.

10. The refuse truck of claim 1, wherein the splitter may be mounted to divide the chambers into equal or different sized configurations.
